(19) United States
(12) Patent Application Publication
(10) Pub. No.: US 2025/0057084 A1
(43) Pub. Date: Feb. 20, 2025

(54) Knitted net for round balers

(71) Applicant: Novatex Italia S.p.A., Oggiono LC (IT)

(72) Inventors: Natale CASTAGNA, Oggiono LC (IT); Marco CASATI, Oggiono LC (IT)

(21) Appl. No.: 18/723,905

(22) PCT Filed: Dec. 27, 2022
(86) PCT No.: PCT/IB2022/062813

§ 371 Date: Jun. 25, 2024

(30) Foreign Application Priority Data
Dec. 28, 2021 (IT) 102021000032813

(51) Int. Cl. A01F 15/08; A01F 15/07; D01D 5/253; D01D 5/42; D04G 1/08

(52) U.S. Cl. CPC A01F 15/08; D01D 5/253; D01D 5/426; D04G 1/08; A01F 15/07; A01F 2015/0745; D10B 2321/021; D10B 2321/022; D10B 2401/22; D10B 2505/00

(57) ABSTRACT

A knitted net (1) for round balers comprises a plurality of equidistant chains (2), arranged parallel to a longitudinal direction of development. Each chain (2) comprises a plurality of knots (3) placed at regular intervals. The adjacent chains (2) are connected to each other by transverse threads (4), at the knots (3). Each transverse thread (4) comprises a plurality of segments (5). In particular, each segment (5) develops between a first knot (3) of a chain (2) and a second knot (3) of an adjacent chain (2), located at a position preceding or following the first knot (3). Each chain (2) comprises a single longitudinal thread (6).

The present disclosure relates to making a knitted net for round balers. This knitted net for round balers can be used to contain different types of forage, such as hay, straw or other types, in round bales with cylindrical shape.

In the state of the art, knitted nets for round balers are known. A knitted net for round balers of the known type is produced from thermoplastic materials. In detail, the knitted net for round balers comprises a first yarn that defines the longitudinal warps, woven in the form of chains. A second yarn defines the weft and connects two neighbouring chains forming a triangular mesh.

The chains that make up the net are spaced 2″ apart and are obtained by weaving two threads of HDPE (high density polyethylene) of rectangular cross-section with a width equal to 1.7 mm and a thickness equal to 30.0 μm. The net has a height equal to 123 cm and is produced by the frame using 25 chains. The use of two threads for each chain is necessary in the nets of known type, as it allows to obtain nets with adequate mechanical characteristics.

The main use of a knitted net for round balers is the containment of different types of forage in round bales with cylindrical shape. The forage, after being cut and in some cases suitably dried, is harvested by means of a round baler into round bales with cylindrical shape. At the end of the harvest cycle, the forage is baled by applying a suitable number of layers of knitted net for round balers on the round bale with cylindrical shape to enable it to be transported.

Once forage harvesting using the net for round balers is finished, the round bales are stored, mainly outdoors.

### SUMMARY OF THE INVENTION

At a disadvantage, the production of such nets entails an environmental impact due to the use of plastic material and a production limit due to the number of threads per frame. The nets, being placed outdoors during their life cycle, are also subject to the action of UV rays, which lead to a degradation of the mechanical properties of the material of the threads, proportional to the thickness of the chain.

In this context, the technical task underlying the present disclosure is to provide a knitted net for round balers which obviates the drawbacks in the prior art as described above.

In particular, an object of the present disclosure is to make available a knitted net for round balers made using less plastics with equal mechanical performance.

A further object of the present disclosure is to make available a knitted net for round balers that exhibits better resistance to the action of UV rays.

### LIST OF FIGURES

Further features and advantages of embodiments of the present invention will become more apparent from the exemplary, and therefore non-limiting, description of a preferred but not exclusive embodiment of a knitted net for round balers, as illustrated in the appended drawings, wherein:

FIG. 1 shows a schematic plan view of a portion of a knitted net for round balers according to an embodiment of the present invention; and

FIG. 2 shows a sectional view of a detail of the net of FIG. 1.

### DETAILED DESCRIPTION

With reference to the accompanying figures, 1 denotes a knitted net for round balers according to embodiments of the present invention.

The net 1 comprises a plurality of chains 2 that develop along a first direction X, parallel to the longitudinal direction. The net 1 also extends along a second direction Y, perpendicular to the first direction X. This net 1 further comprises a plurality of transverse threads 4 that connect two adjacent chains 2 to each other. The chains 2 and the transverse threads 4 define two types of yarn of the structure of the net 1. In particular, the chains 2 define the longitudinal warps, otherwise called Franze or chains. The transverse threads 4, otherwise called Schuss, represent the weft of the net 1. More details on the chains 2 and the transverse threads 4 will be provided in a later part of this disclosure.

In the preferred embodiment, the net 1 extends over a width comprised between 120 and 126 cm along the second direction Y, perpendicular to the first direction X, preferably extending over a width equal to 123 cm. In general, the width of the net along the second direction Y depends on several factors including the type of material, the temperature, the sizes of the chain 2, the tension of the mesh and the geometry of the mesh.

Similarly, the net 1 extends over a length comprised between 1500 and 5000 m along the first direction X, preferably extending over a length equal to 2600 m. In use, the net 1 is wound on a reel (not illustrated) to enable it to be transported.

In particular, because of the geometry of the mesh and of the tension applied, the actual length of the net is always shorter than the length obtained by multiplying the distance between two adjacent chains 2 by the total number of chains 2.

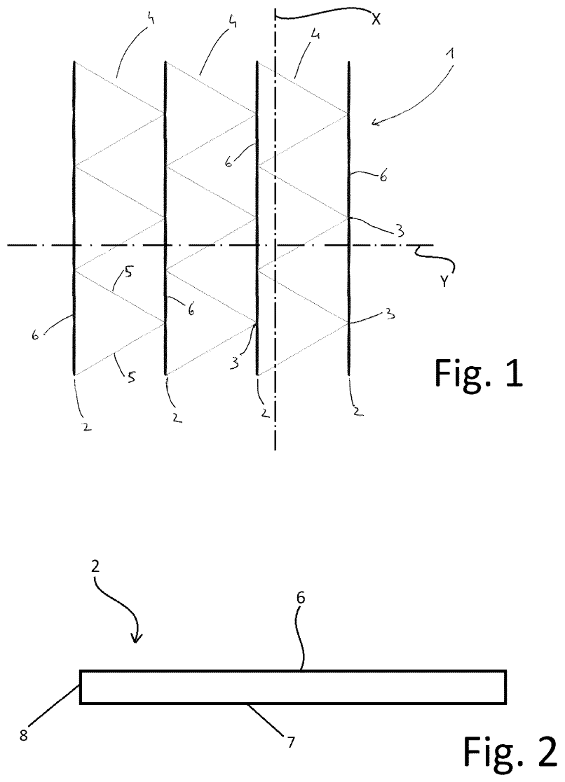

With particular reference to the chains 2 schematically shown in FIG. 1, it should be noted that the distance between two adjacent chains 2 is comprised between 5.00 cm and 5.16 cm, preferably equal to 5.08 cm, so that the total number of chains 2 that make up the net 1 is comprised between 24 and 26, preferably equal to 25.

Each chain 2 comprises a single longitudinal thread 6. This longitudinal thread 6 is made with a mixture of polymers comprising HDPE, polypropylene, additives and stabilizers. HDPE represents the largest contribution by weight of the polymer mixture, while polypropylene makes up at least 3% thereof. Additives and stabilizers are dosed in appropriate concentrations depending on the geographical area of use, in order to adapt the structure of the net 1 to the level of UV radiation present in the location in which it is used, in order to preserve its mechanical properties.

In more detail, each longitudinal thread 6 has a rectangular cross-section having a height 8 comprised between 45 and 60 μm, preferably between 51 and 55 μm, even more preferably equal to 53 μm. The section of the longitudinal thread 6 also has a width 7 comprised between 1.7 and 2.6 mm, preferably between 2.0 and 2.3 mm, even more preferably equal to 2.165 mm. Advantageously, the sizes of the rectangular cross-section, together with the mixture of polymers of which each longitudinal thread 4 is composed, guarantee the mechanical strength necessary for the entire net 1.

Returning now to the transverse threads 4 mentioned above, it should be noted that they connect two adjacent chains 2 at knots 3 placed on the chains 2, in particular on the longitudinal threads 6. Each knot 3 is arranged on the net 1 according to a grid configuration. In particular, the knots 3 are arranged at regular intervals, both along the first direction X, and along the second direction Y. The distance between the knots 3 along the first direction X is comprised between 3.00 cm and 3.04 cm, preferably equal to 3.024 cm, while, along the second direction Y, it is equal to the distance between the chains 2, the knots 3 being placed at the chains 2. The nodes 3 represent the critical points of the net 1, i.e., points where a break of the net 1 is most likely to occur.

Each transverse thread 4 comprises a plurality of segments 5. Each segment 5 connects a knot 3 of a chain 2 to another knot 3 of the adjacent chain 2 in a position of the preceding or following grid with reference to the first direction X. The manner in which the segments 5 connect two adjacent chains 2 defines the mesh geometry of the net 1. In particular, the segments 5 develop between two adjacent chains 2 forming a series of triangular-shaped meshes. The geometry of the net 1 is thus defined as triangular mesh geometry.

The angle comprised between two consecutive segments 5, at a knot 3, is comprised between 60° and 62°, preferably equal to 61°. The angle comprised between a segment 5 and a chain 2, at a knot 3, is comprised between 57° and 62°, preferably equal to 58.9°. The width of this angle guarantees greater grip on the forage, improving its compression and ensuring better waterproofing.

Each segment 5 has a length comprised between 5.7 cm and 6.2 cm, preferably equal to 5.911 cm. The first and last segments 5, placed at the ends of the transverse thread 4, are parallel to the second direction Y, connecting two consecutive knots 3 to each other.

Note that the number of transverse threads 4 in the net 1 is always one element less compared to the total number of chains 2.

When a longitudinal tension is applied on the net 1, the chains 2 stretch. The greater the elongation of the chains 2, the greater the consequent elongation of the transverse threads 4 to maintain the sizes of the net 1.

An embodiment of the present invention also relates to a method for making the net 1 described above. This method comprises the initial step of producing a film of polymeric material. Subsequently, this polymeric film is separated, along the first direction X, into individual strips comprising the longitudinal threads 6. The strips are then oriented along the first direction X to increase their tensile strength. These strips are then knitted using a frame, completing the realisation of the net 1. The pitch of the frame needles corresponds to the distance between two adjacent chains 2 of the finished product, in this case preferably equal to 5.08 cm.

Advantageously, the procedure for making the net 1 is simplified as it requires fewer operations, each chain being made up of a single longitudinal thread 6.

After production, the net 1 is wound onto a reel to enable it to be transported, as already mentioned in the present description. Each reel has a maximum diameter comprised between 15 cm and 30 cm, preferably equal to 25 cm based on the length of the roll.

In use, the net 1 is applied on round bales by means of a round baler, in particular by winding the net 1 on the round bales several times, depending on the type of forage to be contained.

1-10. (canceled)

11. A knitted net for round balers comprising a plurality of chains arranged parallel to a longitudinal direction of development, each chain being equidistant from two adjacent chains, said chains each having a series of knots, the knots of the chains being arranged in a grid along a first direction parallel to the longitudinal direction and along a second direction perpendicular to the first direction; a plurality of transverse threads each arranged between two adjacent chains, each transverse thread comprising a plurality of segments each developing between a first knot of a chain and a second knot located on an adjacent chain, the second knot being located at a position preceding or following the first knot along the first direction; each chain comprising a single longitudinal thread.

12. The net according to claim 11, wherein each longitudinal thread has a rectangular cross-section having a height comprised between 45 and 60 μm, preferably between 51 and 55 μm, a width comprised between 1.7 and 2.6 mm, preferably between 2.0 and 2.3 mm.

13. The net according to claim 12, wherein the height and the width of the cross-section of the longitudinal thread are equal to 53 μm and 2.165 mm, respectively.

14. The net according to claim 11, wherein each longitudinal thread is made with a mixture of polymers comprising at least HDPE and polypropylene.

15. The net according to claim 11, wherein the longitudinal threads and the transverse threads are made of different materials.

16. The net according to claim 15, wherein the mixture of polymers with which the longitudinal threads are made comprises at least 3% by weight of polypropylene.

17. The net according to claim 11, wherein the distance between two adjacent knots along the second direction is comprised between 5.07 cm and 5.09 cm.

18. The net according to claim 11, wherein the distance between two adjacent knots along the first direction is comprised between 3.02 cm and 3.03 cm.

19. The net according to claim 11, wherein said net comprises a number of longitudinal threads comprised between 20 and 30, preferably equal to 25.

20. A method for making a knitted net for round balers according to claim 11, the method comprising the steps of:
producing a film of polymeric material;
separating the film of polymeric material into a plurality of chains each comprising a single longitudinal thread;
knitting the strips by means of a weaving machine for the production of the net;
winding the net onto a reel.
